(19) United States
(12) Patent Application Publication
(10) Pub. No.: US 2008/0130014 A1
(43) Pub. Date: Jun. 5, 2008

(54) Displacement Measurement Sensor Using the Confocal Principle with an Optical Fiber

(76) Inventor: Christopher John Rush, Forestville, CA (US)

Correspondence Address: Christopher Rush, 7475 Poplar Dr, Forestville, CA, 95436, US

(21) Appl. No.: 11/949,895

(22) Filed: Dec. 4, 2007

Related U.S. Application Data
(60) Provisional application No. 60/868,634, filed on Dec. 5, 2006.

(51) Int. Cl. G01B 11/00

(52) U.S. Cl. 356/609

(57) ABSTRACT

A displacement measurement sensor using the confocal principle with an optical fiber for measuring small changes in distance to a specular target surface comprises a monochromatic light source such as a laser diode 12 coupled to a multimode optical fiber. The fiber 32 functions as both a transmitter, receiver of light ray angle information. An objective lens 40 possessing spherical aberration separates the monochromatic light at different focal distances according to the magnitude of angular deviation from the optical axis. Each distance of the target surface from the objective lens will select specific angular rays able to retrace the path through the objective lens and fiber. Each angle then will correspond to specific distance. Angular information is preserved as the light path is traced back through the fiber 32 and the angle measurement is determined by registering the light impinging on a light sensitive electronic detector array 36.

This application claims the benefit of U.S. Provisional Application No. 60/868,634 filed Dec. 5, 2006.

### FIELD OF THE INVENTION

The present invention relates generally to the use of a non-contact optical apparatus to measure displacement of a target over very small incremental changes in distance. More particularly, it relates to an apparatus and method for measuring target displacement when the target surface reflectivity is specular in nature.

### BACKGROUND OF THE INVENTION

Optical distance measurement is widely used in the semiconductor wafer manufacturing industry. The need for precise height information is used primarily in the control of devices that inspect the wafer surfaces for errors or contamination. Semiconductor wafers have specular reflecting surfaces.

Confocal measuring devices are used to measure displacement when the target surface is specular. Optical triangulation measurement devices typically utilize reflected light from diffuse reflecting surfaces. In these devices light projected along a line that is perpendicular to the surface is usually observed at some angle different from perpendicular and the location of the focused image of the light on the diffuse surface is projected on to a light sensitive detecting device. An example of one such devise is disclosed in U.S. Pat. No. 6,088,110.

When the surface is specular, light projected along a line that is perpendicular to the target surface is reflected directly back along the perpendicular and so no distance information can be determined since the return angle is the same for all distances. The confocal principle is therefore the preferred method for measuring distance optically for specular surfaces. Many such confocal systems are known. Examples of such devices are disclosed in U.S. Pat. Nos. 6,934,019, 6,657,216, 6,982,824, and 7,038,793.

The operating principles for existing confocal devices rely on either one or the other of two phenomena:

In the first type of confocal measuring system the chromatic aberration of the objective lens is exploited to determine the distance. The confocal imaging optical setup is an optical setup for imaging a point of light source into a sharp focused second point and then reversing the image from the second point onto a tiny spatial filter. Such an optical setup is absolutely blind for all the space except for the sharply focused second point. Since each wavelength has a different focus length, said setup can be used as a height-measuring device to measure the height of a surface point. A white light beam is separated to its constituent wavelength beams by the optic head and each beam illuminates the surface. The illumination is reflected back through the confocal imaging setup to a spectrometer. Only one wavelength is passed the confocal imaging optical setup, according to the height of the surface, which matches the focal length. The wavelength is detected by the spectrometer and translated to the height of the surface point according to a calibration table. Energy efficiency for devices of this type is low and there is considerable difficulty in coupling broad spectrum white light to a tightly focused point as the system requires.

The second type uses chromatically corrected optics that are mounted on a moving stage. Focus is determined when the return rays pass exactly through a small aperture. To make a measurement, then, the optics are moved by such devices as voice coil or piezoelectric actuators. Displacement can be determined for the target by measuring the displacement of the optics. The disadvantage of this device is that moving the optical components is relatively slow. U.S. Pat. No. 7,038,793 discloses a measuring device that utilizes this principle.

An important difficulty in applying confocal measuring devices is that the measurement is adversely compromised by tilt in the target surface. This target tilt produces an asymmetric signal on the detecting electronics surface that is cross coupled with distance information. Surface tilt contaminates the accuracy of the distance information.

Confocal measuring devices that are presently in use are large and expensive. They also require precision assembly. These devices cannot be brought to close target distance or into restricted spaces. The associated weight of the enclosure containing the optical elements makes them difficult to apply to precision metrology instrumentation. The complex assemblies associated with these devices further restrict them from use in hostile environments such as areas of relatively high or low temperature, or filled with explosive gasses. Surface tilt also compromises the accuracy of the distance measurement.

Thus, there exists a need for an optical measuring device that can determine the displacement of a target when the surface reflectivity is specular. There is also a need to have a distance-measuring probe that is durable in a hostile environment that can be constructed of materials able to withstand high temperature ranges or an explosive atmosphere. There is a further need to measure surfaces that may have a tilt with respect to the measuring axis.

### SUMMARY OF THE INVENTION

A primary object of the invention is to provide a means for accurately determining the distance to a target that is not affected by absolute target reflectivity or variations in source illumination when the target surface reflectivity is specular.

Another object of the invention is to increase the sensitivity of the system so that minute changes in displacement can be measured.

A further object of this invention is to create a configuration that can be of small size and lightweight so that it can be easily applied in restricted spaces, attached to precision instruments, or applied to in process measurement applications.

A further object of this invention is to provide a means for measuring surfaces that is accurate even when the surface is tilted with respect to the measuring axis.

Yet another object of this invention is to provide a means of measuring distance to a target when the sensor head must withstand extreme temperature conditions or explosive gasses.

The non-contact measuring probe of the present invention achieves these objectives by providing an optical probe consisting of an optical objective component possessing spherical aberration that is optically coupled to a high numerical aperture multimode step index fiber. The optical fiber functions to both transmit and receive illumination rays through the objective component on to the target surface. The fiber is further provided with a means to insert a family of monochromatic light rays possessing a variety of angles. This is accomplished by focusing the light from a laser diode or superluminescent diode (SLD) on to the face of the fiber. The cone of focused rays contains the full range of angular distribution with respect to the fiber axis. Rays returned through the system contain only a subset of the original rays. This subset of angular distribution rays is determined by the geometry of the distance between the objective lens and the target surface. An electronic detector is situated some distance from the fiber end is oriented to register the angle of returned rays and thereby provide a measurement of the distance. An important property of the transmitting and receiving fiber is that light rays travel along the length of the fiber by total internal reflection (TIR). Such transmission of light rays by this means preserves the angle of the intercepted rays within the fiber. The angle change due to Snell's law that occurs at the face of the receiving element is exactly reversed when the ray emerges at the other end of the fiber. This angle preservation is also a property of fibers having a circular cross section. From the distal end of such a fiber there emerges a hollow cone shaped fan of light. The angle of the cone is same as the angle of the rays intercepted at the front face of the fiber. This known property of fiber transmission and its use as a principle for a measuring device is disclosed in U.S. Pat. No. 7,071,460. The cone of light emerging from the optical element is then projected on to the surface of a position-sensitive transducer PSD or a linear CCD array or two-dimensional array. The diameter of the cone shaped light is easily measured as the location of the centroid of the of optical power distribution on a linear array or as the best fit of a circular function to the power distribution as registered on the two-dimensional array.

Since one embodiment of the present invention may be constructed so that the measuring head consists only of a glass lens, a glass multi-mode fiber for transmitting and receiving optical energy, it is readily apparent that such a construction is rugged, compact, and capable of operating in a hostile environment. This also achieves the object of compact size and lightweight.

Position sensing of optical energy on multi-element linear or two-dimensional arrays may be realized with very high precision. This achieves the object of the invention to devise a probe having high accuracy.

Since the asymmetry of the reflected energy produced by a tilted surface is redistributed into a rotationally symmetric signal about the fiber axis. It is a further property of fiber transmission that the asymmetry of the received rays from a tilted surface are redistributed symmetrically about the mean of the measuring angle rays so that the net error in the measurement signal is exactly cancelled. The distribution of the measured signal is increased but the mean location of the centroid is unchanged. In this way the object of measurement insensitivity to tilt is achieved.

### BRIEF DESCRIPTION OF THE DRAWINGS

FIG. 1 shows a diagram of the preferred embodiment of the invention.

FIG. 2a-e show ray-trace simulations for the illumination distribution on the plane of the detector for a series of increasing distances of the target.

FIG. 3 shows a diagram for an alternate embodiment. In this form a cylinder lens has been disposed in front of the detector array as a way of concentrating the intensity of the illumination in the ring shape onto the detector.

FIG. 4 shows the same apparatus in which the method for concentrating the intensity of the illumination on the detector array is an astigmatic mirror.

### DETAILED DESCRIPTION OF THE INVENTION

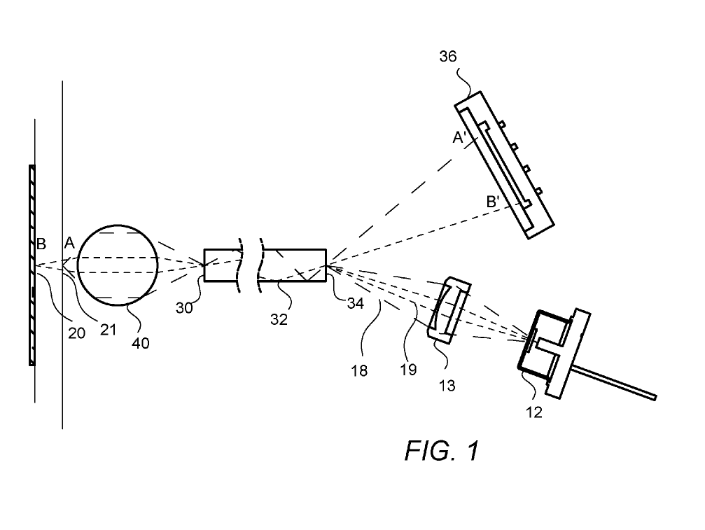

A displacement measurement sensor will now be described according to the invention. Referring to FIG. 1 in the preferred embodiment the device consists of a laser diode 12 projecting a cone of monochromatic light rays 18,19 into to a high numerical aperture (N.A.) multimode step index fiber 32 at fiber face 34 using an intermediate lens 13 which gathers light from the laser diode 12 and focuses it onto the fiber face 34. Within the cone of focused rays of light there is a full range of angular distributions. Some rays 19 make small angles with respect to the optical axis, while other rays 18 make relatively larger angles with respect to the optical axis. In this preferred embodiment fiber face 34 has an anti-reflection coating. The axis of the laser and lens optical system is tilted with respect to the fiber axis so that on-axis rays are not introduced into the fiber 32. Laser light energy is conducted along the fiber by total internal reflection. Light rays emerging from the fiber face 30 are refracted by lens 40. A property of lens 40 is that it possesses spherical aberration. Spherical aberration is described as the difference in focal length according to the distance of the rays from the optical axis of the lens. In this preferred embodiment the rays that are refracted by the region of the lens near to the optical axis—also called the paraxial rays—focus at a distance relatively far from the lens 40 at point B. Rays relatively far from the optical axis—also called tangential rays—focus at a distance relatively nearer to the lens at point A. It follows from this that rays reflected by the specular target 20 will only travel back through the optical system after a reflection angle that is exactly equal to the angle of incidence. This is the fundamental definition of specular reflection. Thus if the target is near to the lens the reflected rays that will be able to travel back through the system will be the tangential rays. When the target is relatively far from the lens, the reflected rays able to traverse the system will only be the paraxial rays. In this way the position of the target surface will select which subset of the family of all rays that are able to travel the exact reverse path and re-emerge from the fiber at face 34. Rays emerging from face 34 are distributed in a cone shape. The apex angle of the cone of rays is determined by the selection of the subset from the family of all angles according to the principle described above. Rays emerging from face 34 fall on detector array 36. This is an array of light sensitive elements such as is manufactured by Texas Advanced Optoelectronics Solutions, Inc. product number TSLW1401. Array 36 registers an intensity distribution according to the angular distribution of rays in the emergent cone of rays. Low angle rays from a small apex cone of paraxial rays will register higher intensity illumination at region B′ on the detector array. Higher angle tangential rays from a relatively nearer target will register higher intensity illumination on region A′ on the detector array.

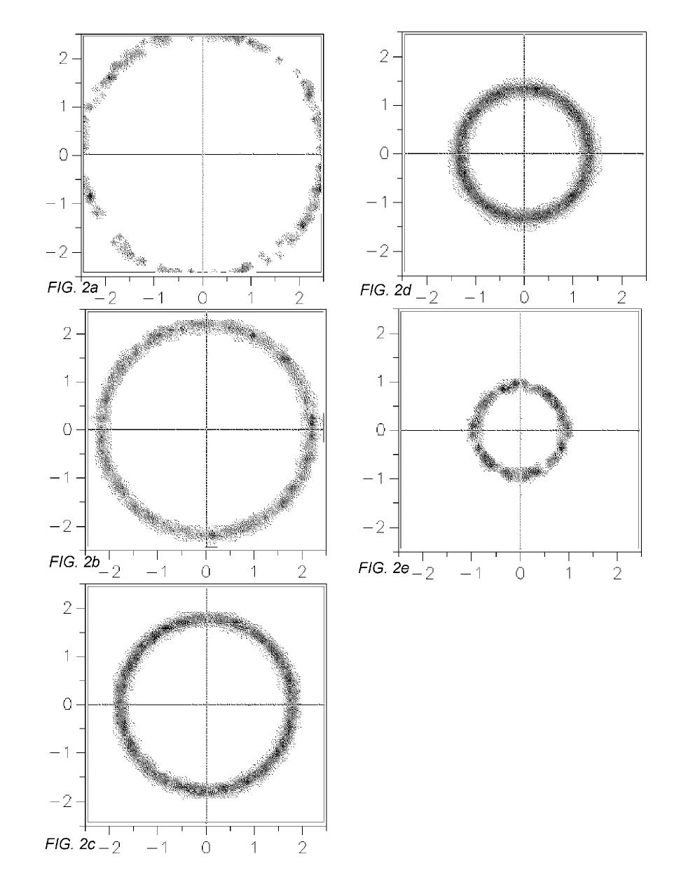

FIG. 2a-e Show the illumination pattern produced by the system for various distances of the target to the lens. For the preferred embodiment described in FIG. 1 the scale of the images is shown in millimeters and if FIG. 2a is given as the zero datum then each successive image represents an increasing distance change of 1 mm. The specific properties of the range and resolution may be chosen by selecting components having different degrees of spherical aberration. The magnitude of spherical aberration is primarily determined by selecting the index of refraction, and curvature of the objective optical component.

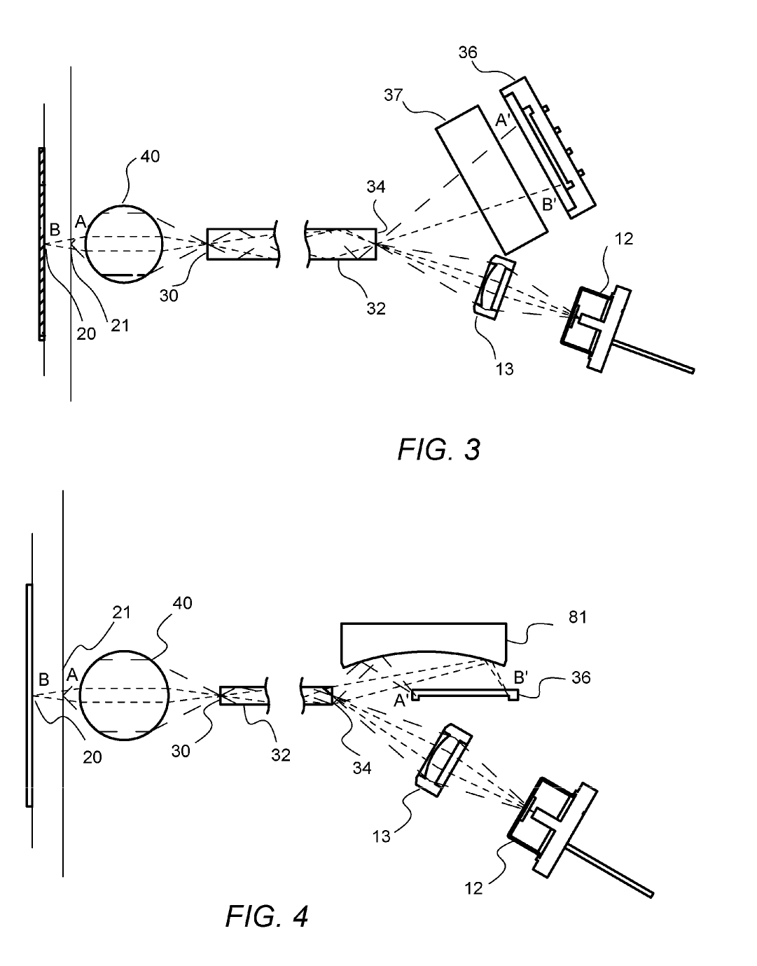

Another embodiment of the present invention is shown in FIG. 3. In this embodiment the sensitivity of the receiving electronic detector is enhanced by the addition of cylinder lens 37. The cylinder lens focuses light in a single axis only. In this way a larger portion of the projected ring of light is gathered on to the detector array 36. The angular information is not lost because in this dimension the cylinder lens does not refract the rays.

Another embodiment of the present invention is shown in FIG. 4. In this embodiment the sensitivity of the receiving electronic detector is enhanced by the addition of astigmatic mirror 81. This optical component provides additional gathering power by focusing light in two different dimensions. Detector array 36 has been relocated to the plane that passes through the axis of the fiber. One focus of the astigmatic lens is created at this plane by creating the surface of revolution around the fiber axis. The second focal center is located off this axis and is chosen according to the diameter of the fiber and the range of measurement.

It is now apparent that the non-contact measuring probe sensor of the present invention, as described and illustrated above, shows many improvements over available probe sensors. It is to be understood, however, that although certain preferred embodiments have been disclosed and described above, other embodiments and changes are possible without departing from that which is the invention disclosed herein. It is intended therefore that claims in any non-provisional patent claiming the benefit of this provisional application define the invention, and that the structure within the scope of those claims and their equivalents be covered thereby.

I claim:

1. A confocal optical measuring probe for measuring distance to a reflective target, the probe comprising:
a light source for projecting focused light rays onto the end face of a substantially cylindrically shaped optical component,
said cylindrically shaped optical component possessing the capability for transmitting light rays by total internal reflection,
a second optical component possessing spherical aberration that receives rays from the said cylindrically shaped component, and produces a distribution of focal points at varying distances along the measuring axis,
said second optical component for receiving reflected rays from the target for focusing rays into the said cylindrically shaped optical component, and
a light detector for measuring the angle of rays emerging from said cylindrically shaped optical component.

2. A confocal optical measuring probe of claim 1 wherein: said light source includes a laser.

3. A confocal optical measuring probe of claim 1 wherein: said light source includes a superluminescent diode.

4. A confocal optical measuring probe of claim 1 wherein: said light source includes an LED.

5. A confocal optical measuring probe of claim 1 wherein: said cylindrically shaped optical component includes a multi-mode step index optical fiber.

6. A confocal optical measuring probe of claim 1 wherein: said optical component possessing spherical aberration comprises a plurality of lenses.

7. A confocal optical measuring probe of claim 1 wherein: said light detector includes a linear array.

8. A confocal optical measuring probe of claim 1 wherein: said light detector includes a position sensitive detector.
